(19) United States
(12) Patent Application Publication
(10) Pub. No.: US 2010/0056711 A1
(43) Pub. Date: Mar. 4, 2010

(54) CONJUGATED DIENE POLYMER CONJUGATED DIENE POLYMER COMPOSITION

(75) Inventors: Toru FUJII, Chiba (JP); Seiichi MABE, Ehime (JP); Mayumi OSHIMA, Bartlesville, OK (US)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/546,455

(22) Filed: Aug. 24, 2009

(30) Foreign Application Priority Data
Aug. 27, 2008 (JP) 2008-217838

(51) Int. Cl. C08L 9/00; C08F 4/46; C08F 230/08

(52) U.S. Cl. 524/571; 526/173; 526/279

(57) ABSTRACT

There is provided a continuous method for producing a conjugated diene polymer, comprising: polymerizing a conjugated diene, a compound of formula (I) below, and optionally other monomer in the presence of an alkali metal catalyst in a hydrocarbon solvent,

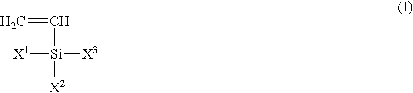

wherein X¹, X², and X³ independently denote a group as defined in the specification.

### TECHNICAL FIELD

The present invention relates to a conjugated diene polymer and a conjugated diene polymer composition.

### BACKGROUND ART

In recent years, with the growing concern over environmental problems the demand for good fuel economy for automobiles has been becoming stronger, and there is also a demand for excellent fuel economy for polymer compositions used for automobile tires. As such a polymer composition for automobile tires, a polymer composition formed by combining a conjugated diene polymer such as polybutadiene or a butadiene-styrene copolymer with a filler such as carbon black or silica or an additive such as an extender oil or a vulcanizing accelerator is used.

For example, a polymer composition formed by mixing a styrene-butadiene copolymer rubber produced by a batch polymerization method with carbon black, a vulcanizer, a vulcanizing accelerator, etc. is known (see e.g. JP•A•57-55912, JP•A•57-87407, JP•A denotes a Japanese unexamined patent publication application). Furthermore, a polymer composition formed by mixing a styrene-butadiene copolymer rubber produced by a continuous polymerization method with an extender oil, carbon black, a vulcanizer, a vulcanizing accelerator, etc. is known (see e.g. JP•A•61-255908).

### DISCLOSURE OF THE INVENTION

However, when the conjugated diene polymer is melt-kneaded together with an additive by means of a kneader and a polymer composition thus obtained is taken out from the kneader, the polymer composition sometimes adheres to an inner wall face of the kneader and is left behind, and the conventional conjugated diene polymer is not always satisfactory in terms of kneading processability.

Under such circumstances, an object of the present invention is to provide a conjugated diene polymer having excellent kneading processability and a polymer composition containing the conjugated diene polymer and a filler.

The above-mentioned object has been accomplished by means described in [1] and [5]. They are described below together with [2] to [4], which are preferred embodiments.

[1] A continuous method for producing a conjugated diene polymer, comprising polymerizing a conjugated diene, a compound of formula (I) below, and optionally other monomer in the presence of an alkali metal catalyst in a hydrocarbon solvent,

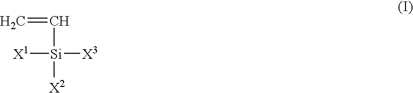

wherein X¹, X², and X³ independently denote a group of formula (II) below, a hydrocarbyl group, or a substituted hydrocarbyl group, and at least one of X¹, X², and X³ is a group of formula (II) below,

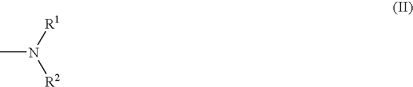

wherein R¹ and R² independently denote a hydrocarbyl group having 1 to 9 carbon atoms, a substituted hydrocarbyl group having 1 to 9 carbon atoms, a silyl group, or a substituted silyl group, and R¹ and R² may be bonded so as to form, together with the nitrogen atom, a ring structure,
[2] the method according to [1], wherein said other monomer is an aromatic vinyl compound,
[3] the method according to [1] or [2], wherein the vinyl bond content of the conjugated diene polymer is not less than 20 mol % and not more than 70 mol % per 100 mol % of the conjugated diene-based constituent unit,
[4] a conjugated diene polymer obtained by the method according to any one of [1] to [3],
[5] a conjugated diene polymer composition comprising the conjugated diene polymer according to [4]; and a filler.

### MODE FOR CARRYING OUT THE INVENTION

The conjugated diene polymer of the present invention is a continuous method for producing a conjugated diene polymer, comprising polymerizing a conjugated diene, a compound of formula (I) below, and optionally other monomer in the presence of an alkali metal catalyst in a hydrocarbon solvent,

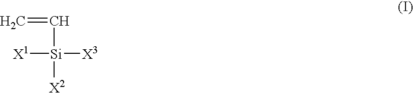

wherein X¹, X², and X³ independently denote a group of formula (II) below, a hydrocarbyl group, or a substituted hydrocarbyl group, and at least one of X¹, X², and X³ is a group of formula (II) below,

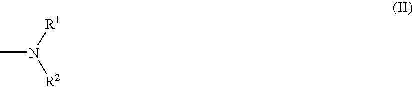

wherein R¹ and R² independently denote a hydrocarbyl group having 1 to 9 carbon atoms, a substituted hydrocarbyl group having 1 to 9 carbon atoms, a silyl group, or a substituted silyl group, and R¹ and R² may be bonded so as to form, together with the nitrogen atom, a ring structure.

In the present invention, the description ‘A to B’ expressing a range of numerical values means ‘not less than A but not more than B’. That is, it expresses a range of numerical values that includes the endpoints A and B.

The conjugated diene is not particularly limited as long as it is a compound having a conjugated diene, in which double bonds are separated by one single bond.

Examples of the conjugated diene include 1,3-butadiene, isoprene, 1,3-pentadiene, 2,3-dimethyl-1,3-butadiene, and 1,3-hexadiene, and one type thereof may be used or two or more types may be used. From the viewpoint of ready availability, 1,3-butadiene and isoprene are preferable.

X¹, X², and X³ in formula (I) independently denote a group of formula (II) below, a hydrocarbyl group, or a substituted hydrocarbyl group, and at least one of X¹, X², and X³ is a group of formula (II) below,

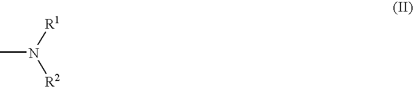

wherein R¹ and R² independently denote a hydrocarbyl group having 1 to 9 carbon atoms, a substituted hydrocarbyl group having 1 to 9 carbon atoms, a silyl group, or a substituted silyl group, and R¹ and R² may be bonded so as to form, together with the nitrogen atom, a ring structure.

R¹ and R² independently denote a hydrocarbyl group having 1 to 9 carbon atoms, preferably having 1 to 6 carbon atoms, a substituted hydrocarbyl group having 1 to 9 carbon atoms, preferably having 1 to 6 carbons, a silyl group, or a substituted silyl group, and R¹ and R² may be bonded so as to form, together with the nitrogen atom, a ring structure.

In the present specification, the hydrocarbyl group denotes a hydrocarbon residue. The substituted hydrocarbyl group denotes a group in which at least one hydrogen atom of the hydrocarbon residue is replaced by a substituent. The substituted silyl group denotes a group in which at least one hydrogen atom of the silyl group is replaced by a substituent.

Examples of the hydrocarbyl group having 1 to 9 carbon atoms denoted by R¹ and R² include an alkyl group such as a methyl group, an ethyl group, an n-propyl group, an isopropyl group, an n-butyl group, a sec-butyl group, a tert-butyl group, an n-pentyl group, a neopentyl group, an isopentyl group, or an n-hexyl group; a cycloalkyl group such as a cyclohexyl group; and a phenyl group. Examples of the substituted hydrocarbyl group having 1 to 9 carbon atoms include an alkoxyalkyl group such as a methoxymethyl group, a methoxyethyl group, an ethoxymethyl group, or an ethoxyethyl group. Examples of the substituted silyl group include a trialkylsilyl group such as a trimethylsilyl group, a triethylsilyl group, or a t-butyldimethylsilyl group.

Examples of the group in which R¹ and R² are bonded include an alkylene group such as a trimethylene group, a tetramethylene group, a pentamethylene group, or a hexamethylene group; an oxydialkylene group such as an oxydiethylene group or an oxydipropylene group; and a nitrogen-containing group such as a group represented by —CH₂CH₂—NH—CH₂— or a group represented by —CH₂CH₂—N═CH—.

The group in which R¹ and R² are bonded is preferably a nitrogen-containing group, and more preferably a group represented by —CH₂CH₂—NH—CH₂— or a group represented by —CH₂CH₂—N═CH—.

The hydrocarbyl group denoted by R¹ and R² is preferably an alkyl group, more preferably a methyl group, an ethyl group, an n-propyl group, or an n-butyl group, and yet more preferably an ethyl group or an n-butyl group. The substituted hydrocarbyl group denoted by R¹ and R² is preferably a substituted hydrocarbyl group having as a substituent at least one type of group selected from the group consisting of a nitrogen atom-containing group, an oxygen atom-containing group, and a silicon atom-containing group, and is more preferably an alkoxyalkyl group. The substituted silyl group denoted by R¹ and R² is preferably a trialkylsilyl group, and more preferably a trimethylsilyl group.

R¹ and R² are preferably hydrocarbyl groups having 1 to 4 carbon atoms, substituted hydrocarbyl groups having 1 to 4 carbon atoms, substituted silyl groups, or nitrogen-containing groups in which R¹ and R² are bonded, and more preferably hydrocarbyl groups having 1 to 4 carbon atoms.

Examples of the group of formula (II) include an acyclic amino group and a cyclic amino group.

Examples of the acyclic amino group include a dialkylamino group such as a dimethylamino group, a diethylamino group, a di(n-propyl)amino group, a di(isopropyl)amino group, a di(n-butyl)amino group, a di(sec-butyl)amino group, a di(tert-butyl)amino group, a di(neopentyl)amino group, or an ethylmethylamino group; a di(alkoxyalkyl)amino group such as a di(methoxymethyl)amino group, a di(methoxyethyl)amino group, a di(ethoxymethyl)amino group, or a di(ethoxyethyl)amino group; and a di(trialkylsilyl)amino group such as a di(trimethylsilyl)amino group or a di(t-butyldimethylsilyl)amino group.

Examples of the cyclic amino group include a 1-polymethyleneimino group such as a 1-pyrrolidinyl group, a 1-piperidino group, a 1-hexamethyleneimino group, a 1-heptamethyleneimino group, a 1-octamethyleneimino group, a 1-decamethyleneimino group, a 1-dodecamethyleneimino group, a 1-tetradecamethyleneimino group, or a 1-octadecamethyleneimino group. Further examples of the cyclic amino group include a 1-imidazolyl group, a 4,5-dihydro-1-imidazolyl group, a 1-imidazolidinyl group, a 1-piperazinyl group, and a morpholino group.

From the viewpoint of economy and ready availability, the group of formula (II) is preferably an acyclic amino group, more preferably a dialkylamino group, and yet more preferably a dimethylamino group, a diethylamino group, a di(n-propyl)amino group, or a di(n-butyl)amino group.

Examples of the hydrocarbyl group denoted by X¹ to X³ of formula (I) include an alkyl group such as a methyl group, an ethyl group, an n-propyl group, an isopropyl group, an n-butyl group, a sec-butyl group, or a tert-butyl group. Furthermore, examples of the substituted hydrocarbyl group include an alkoxyalkyl group such as a methoxymethyl group, an ethoxymethyl group, a methoxyethyl group, or an ethoxyethyl group.

The hydrocarbyl group denoted by X¹ to X³ is preferably an alkyl group, and more preferably a methyl group or an ethyl group. Furthermore, the substituted hydrocarbyl group denoted by X¹ to X³ is preferably an alkoxyalkyl group.

The hydrocarbyl group or substituted hydrocarbyl group denoted by X¹ to X³ is preferably a hydrocarbyl group having 1 to 4 carbon atoms or a substituted hydrocarbyl group having 1 to 4 carbon atoms, more preferably a hydrocarbyl group having 1 to 4 carbon atoms, and yet more preferably a methyl group or an ethyl group.

At least one of X¹, X², and X³ of formula (I) is a group of formula (II). It is preferable that two or more of X¹, X², and X³ are group of formula (II), and it is more preferable that two of X¹, X², and X³ are groups of formula (II).

With regard to the compound of formula (I), as compounds in which one of X¹ to X³ is an acyclic amino group of formula (II) and two thereof are hydrocarbyl groups or substituted hydrocarbyl groups there can be cited a (dialkylamino)dialkylvinylsilane, a {di(trialkylsilyl)amino}dialkylvinylsilane, a (dialkylamino)dialkoxyalkylvinylsilane, etc.

Examples of the (dialkylamino)dialkylvinylsilane include (dimethylamino)dimethylvinylsilane, (ethylmethylamino)dimethylvinylsilane, (diethylamino)dimethylvinylsilane, (ethyl-n-propylamino)dimethylvinylsilane, (ethylisopropylamino)dimethylvinylsilane, (di-n-propylamino)dimethylvinylsilane, (diisopropylamino)dimethylvinylsilane, (n-butyl-n-propylamino)dimethylvinylsilane, (di-n-butylamino)dimethylvinylsilane, (dimethylamino)diethylvinylsilane, (ethylmethylamino)diethylvinylsilane, (diethylamino)diethylvinylsilane, (ethyl-n-propylamino)diethylvinylsilane, (ethylisopropylamino)diethylvinylsilane, (di-n-propylamino)diethylvinylsilane, (diisopropylamino)diethylvinylsilane, (n-butyl-n-propylamino)diethylvinylsilane, (di-n-butylamino)diethylvinylsilane, (dimethylamino)dipropylvinylsilane, (ethylmethylamino)dipropylvinylsilane, (diethylamino)dipropylvinylsilane, (ethyl-n-propylamino)dipropylvinylsilane, (ethylisopropylamino)dipropylvinylsilane, (di-n-propylamino)dipropylvinylsilane, (diisopropylamino)dipropylvinylsilane, (n-butyl-n-propylamino)dipropylvinylsilane, (di-n-butylamino)dipropylvinylsilane, (dimethylamino)dibutylvinylsilane, (ethylmethylamino)dibutylvinylsilane, (diethylamino)dibutylvinylsilane, (ethyl-n-propylamino)dibutylvinylsilane, (ethylisopropylamino)dibutylvinylsilane, (di-n-propylamino)dibutylvinylsilane, (diisopropylamino)dibutylvinylsilane, (n-butyl-n-propylamino)dibutylvinylsilane, and (di-n-butylamino)dibutylvinylsilane.

Examples of the {di(trialkylsilyl)amino}dialkylvinylsilane include {di(trimethylsilyl)amino}dimethylvinylsilane, {di(t-butyldimethylsilyl)amino}dimethylvinylsilane, {di(trimethylsilyl)amino}diethylvinylsilane, and {di(t-butyldimethylsilyl)amino}diethylvinylsilane.

Examples of the (dialkylamino)dialkoxyalkylvinylsilane include (dimethylamino)dimethoxymethylvinylsilane, (dimethylamino)dimethoxyethylvinylsilane, (dimethylamino)diethoxymethylvinylsilane, (dimethylamino)diethoxyethylvinylsi lane, (diethylamino)dimethoxymethylvinylsilane, (diethylamino)dimethoxyethylvinylsilane, (diethylamino)diethoxymethylvinylsilane, and (diethylamino)diethoxyethylvinylsilane.

As a compound in which two of X¹ to X² are acyclic amino groups of formula (II) and one thereof is a hydrocarbyl group or a substituted hydrocarbyl group there can be cited a bis(dialkylamino)alkylvinylsilane, a bis{di(trialkylsilyl)amino}alkylvinylsilane, a bis(dialkylamino)alkoxyalkylvinylsilane, etc.

Examples of the bis(dialkylamino)alkylvinylsilane include bis(dimethylamino)methylvinylsilane, bis(ethylmethylamino)methylvinylsilane, bis(diethylamino)methylvinylsilane, bis(ethyl-n-propylamino)methylvinylsilane, bis(ethylisopropylamino)methylvinylsilane, bis(di-n-propylamino)methylvinylsilane, bis(diisopropylamino)methylvinylsilane, bis(n-butyl-n-propylamino)methylvinylsilane, bis(di-n-butylamino)methylvinylsilane, bis(dimethylamino)ethylvinylsilane, bis(ethylmethylamino)ethylvinylsilane, bis(diethylamino)ethylvinylsilane, bis(ethyl-n-propylamino)ethylvinylsilane, bis(ethylisopropylamino)ethylvinylsilane, bis(di-n-propyl)amino)ethylvinylsilane, bis(diisopropylamino)ethylvinylsilane, bis(n-butyl-n-propylamino)ethylvinylsilane, bis(di-n-butylamino)ethylvinylsilane, bis(dimethylamino)propylvinylsilane, bis(ethylmethylamino)propylvinylsilane, bis(diethylamino)propylvinylsilane, bis(ethyl-n-propylamino)propylvinylsilane, bis(ethylisopropylamino)propylvinylsilane, bis(di-n-propylamino)propylvinylsilane, bis(d iisopropylamino)propylvinylsilane, bis(n-butyl-n-propylamino)propylvinylsilane, bis(di-n-butylamino)propylvinylsilane, bis(dimethylamino)butylvinylsilane, bis(ethylmethylamino)butylvinylsilane, bis(diethylamino)butylvinylsilane, bis(ethyl-n-propylamino)butylvinylsilane, bis(ethylisopropylamino)butylvinylsilane, bis(di-n-propylamino)butylvinylsilane, bis(diisopropylamino)butylvinylsilane, bis(n-butyl-n-propylamino)butylvinylsilane, and bis(di-n-butylamino)butylvinylsilane.

Examples of the bis{di(trialkylsilyl)amino}alkylvinylsilane include bis{di(trimethylsilyl)amino}methylvinylsilane, bis{di(t-butyldimethylsilyl)amino}methylvinylsilane, bis{di(trimethylsilyl)amino}ethylvinylsilane, and bis{di(t-butyldimethylsilyl)amino}ethylvinylsilane.

Examples of the bis(dialkylamino)alkoxyalkylvinylsilane include bis(dimethylamino)methoxymethylvinylsilane, bis(dimethylamino)methoxyethylvinylsilane, bis(dimethylamino)ethoxymethylvinylsilane, bis(dimethylamino)ethoxyethylvinylsilane, bis(diethylamino)methoxymethylvinylsilane, bis(diethylamino)methoxyethylvinylsilane, bis(diethylamino)ethoxymethylvinylsilane, and bis(diethylamino)ethoxyethylvinylsilane.

Examples of the compounds in which three of X¹ to X³ are acyclic amino groups of formula (II) include a tri(dialkylamino)vinylsilane, etc.

Examples thereof include tri(dimethylamino)vinylsilane, tri(ethylmethylamino)vinylsilane, tri(diethylamino)vinylsilane, tri(ethylpropylamino)vinylsilane, tri(dipropylamino)vinylsilane, and tri(butylpropylamino)vinylsilane.

Examples of compounds in which two of X¹ to X³ are cyclic amino groups of formula (II) and one thereof is a hydrocarbyl group or a substituted hydrocarbyl group include bis(morpholino)methylvinylsilane, bis(piperidino)methylvinylsilane, bis(4,5-dihydroimidazolyl)methylvinylsilane, and bis(hexamethyleneimino)methylvinylsilane.

The vinyl compound of formula (I) in which two of X¹ to X³ are groups of formula (II) is preferably a vinyl compound in which two of X¹, X², and X³ are acyclic amino groups; from the viewpoint of fuel economy and grip properties it is more preferably a bis(dialkylamino)alkylvinylsilane, and yet more preferably bis(dimethylamino)methylvinylsilane, bis(diethylamino)methylvinylsilane, bis(di-n-propylamino)methylvinylsilane, or bis(di-n-butylamino)methylvinylsilane. Among them, from the viewpoint of availability of the compound, bis(diethylamino)methylvinylsilane or bis(di-n-butylamino)methylvinylsilane is preferable.

In the polymerization of a conjugated diene and a compound of formula (I), polymerization may be carried out in combination with other monomer as necessary. As said other monomer an ethylenically unsaturated compound is preferable, and specific examples thereof include an aromatic vinyl, a vinylnitrile, and an unsaturated carboxylic acid ester. Examples of the aromatic vinyl include styrene, α-methylstyrene, vinyltoluene, vinylnaphthalene, divinylbenzene, trivinylbenzene, and divinylnaphthalene. Examples of the vinylnitrile include acrylonitrile, and examples of the unsaturated carboxylic acid ester include methyl acrylate, ethyl acrylate, methyl methacrylate, and ethyl methacrylate. Among them, an aromatic vinyl is preferable, and styrene is more preferable.

Examples of the alkali metal catalyst, used as a polymerization initiator, include an alkali metal, an organoalkali metal compound, a complex between an alkali metal and a polar compound, an oligomer having an alkali metal, etc. Examples of the alkali metal include lithium, sodium, potassium, rubidium, and cesium. Examples of the organoalkali metal compound include ethyllithium, n-propyllithium, iso-propyllithium, n-butyllithium, sec-butyllithium, t-octyllithium, n-decyllithium, phenyllithium, 2-naphthyllithium, 2-butylphenyllithium, 4-phenylbutyllithium, cyclohexyllithium, 4-cyclopentyllithium, dimethylaminopropyllithium, diethylaminopropyllithium, t-butyldimethylsilyloxypropyllithium, N-morpholinopropyllithium, lithium hexamethyleneimide, lithium pyrrolidide, lithium piperidide, lithium heptamethyleneimide, lithium dodecamethyleneimide, 1,4-dilithio-2-butene, sodium naphthalenide, sodium biphenylide, and potassium naphthalenide. Examples of the complex between an alkali metal and a polar compound include a potassium-tetrahydrofuran complex and a potassium-diethoxyethane complex, and examples of the oligomer having an alkali metal include the sodium salt of α-methylstyrene tetramer. Among them, an organolithium compound or an organosodium compound is preferable, and an organolithium compound or organosodium compound having 2 to 20 carbon atoms is more preferable.

The amount of polymerization initiator that may be used per 100 parts by weight of the total of the conjugated diene, compound of formula (I), and other monomer, if used (total of polymerizable components), is preferably 0.00001 to 5 parts by weight (or % by mol), more preferably 0.0005 to 1 parts by weight, and yet more preferably 0.01 to 0.5 parts by weight.

The amount of polymerization initiator is preferably in the above-mentioned range since a polymerization reaction progresses quickly and the influence of residual polymerization initiator is suppressed.

The hydrocarbon solvent does not deactivate the alkali metal catalyst, and examples thereof include an aliphatic hydrocarbon, an aromatic hydrocarbon, and an alicyclic hydrocarbon. Specific examples of the aliphatic hydrocarbon include propane, n-butane, iso-butane, n-pentane, iso-pentane, n-hexane, propene, 1-butene, iso-butene, trans-2-butene, cis-2-butene, 1-pentene, 2-pentene, 1-hexene, and 2-hexene. Specific examples of the aromatic hydrocarbon include benzene, toluene, xylene, and ethylbenzene, and specific examples of the alicyclic hydrocarbon include cyclopentane and cyclohexane. They may be used alone or in combination with a different hydrocarbon solvent(s). Among them, a hydrocarbon having 2 to 12 carbon atoms is preferable.

The hydrocarbon solvent is used such that the total solids concentration in a reaction mixture containing the hydrocarbon solvent, an alkali metal catalyst, a conjugated diene, a compound of formula (I), optionally other monomer, and other components in the continuous polymerization method is preferably 1 to 80% by weight, more preferably 5 to 60% by weight, and yet more preferably 10 to 40% by weight.

The amount of hydrocarbon solvent that may be used is preferably in the above-mentioned range to obtain high reactivity.

The polymerization may be carried out in the presence of an agent for regulating the vinyl bond content of the conjugated diene unit, an agent for regulating the distribution in the conjugated diene polymer chain of the conjugated diene unit and a constituent unit based on a monomer other than the conjugated diene (hereinafter, generally called ‘regulators’), etc. Examples of such agents include an ether compound, a tertiary amine, and a phosphine compound. Specific examples of the ether compound include cyclic ethers such as tetrahydrofuran, tetrahydropyran, and 1,4-dioxane; aliphatic monoethers such as diethyl ether and dibutyl ether; aliphatic diethers such as ethylene glycol dimethyl ether, ethylene glycol diethyl ether, ethylene glycol dibutyl ether, diethylene glycol diethyl ether, and diethylene glycol dibutyl ether; and aromatic ethers such as diphenyl ether and anisole. Specific examples of the tertiary amine include triethylamine, tripropylamine, tributylamine, N,N,N′,N′-tetramethylethylenediamine, N,N-diethylaniline, pyridine, and quinoline. Specific examples of the phosphine compound include trimethylphosphine, triethylphosphine, and triphenylphosphine. They may be used on their own or in a combination of two or more types.

The amount of regulator added depends on a target vinyl bond content or polymerization temperature, but it is preferably 0.01 to 50 as a ratio by mol relative to the alkali metal catalyst, more preferably 0.05 to 10, and yet more preferably 0.1 to 2.

In the polymerization, a coupling agent may be added to a polymerization solution as necessary. Examples of the coupling agent include a compound of formula (III) below,

R³ₐML₄₋ₐ (III)

wherein R³ denotes an alkyl group, an alkenyl group, a cycloalkenyl group, or an aromatic residue, M denotes a silicon atom or a tin atom, L denotes a halogen atom or a hydrocarbyloxy group, and a denotes an integer of 0 to 2.

Here, the aromatic residue denotes a monovalent group in which a hydrogen bonded to an aromatic ring is removed from an aromatic hydrocarbon, and the hydrocarbyloxy group denotes a group in which the hydrogen atom of a hydroxy group is replaced by a hydrocarbyl group.

Examples of the coupling agent of formula (III) include silicon tetrachloride, methyltrichlorosilane, dimethyldichlorosilane, trimethylchlorosilane, tin tetrachloride, methyltrichlorotin, dimethyldichlorotin, trimethylchlorotin, tetramethoxysilane, methyltrimethoxysilane, dimethoxydimethylsilane, methyltriethoxysilane, ethyltrimethoxysilane, dimethoxydiethylsilane, diethoxydimethylsilane, tetraethoxysilane, ethyltriethoxysilane, and diethoxydiethylsilane.

From the viewpoint of mixture uniformity of a composition when a conjugated diene polymer and another component are melt-mixed, the amount of coupling agent that may be added is preferably not less than 0.03 mol per mol of the alkali metal originating from the alkali metal catalyst, and more preferably not less than 0.05 mol. Furthermore, from the viewpoint of fuel economy, it is preferably not more than 0.4 mol, and more preferably not more than 0.3 mol.

In the polymerization, an agent for modifying a polymer (polymer modifier) may be added to a polymerization solution as necessary. Examples of the polymer modifier include an amino compound such as N,N-dimethylformamide or a dialkylaminobenzophenone.

The amount of polymer modifier that may be added is not particularly limited, but is preferably 0.1 to 3 moles per mol of the alkali metal catalyst, more preferably 0.5 to 2 moles, and yet more preferably 0.7 to 1.5 moles.

Continuous polymerization is usually carried out using one or two reactors by continuously supplying a conjugated diene, a compound of formula (I), and optionally other monomer, a hydrocarbon solvent, and an alkali metal catalyst to the reactor, and continuously discharging the polymerization product from the reactor.

That is, the continuous polymerization method referred to here includes continuous supply of a reaction mixture containing a conjugated diene, a compound of formula (I), other monomer that may be additionally used, a hydrocarbon solvent, and an alkali metal catalyst to a reactor and continuous discharge from the reactor of an amount of polymerization product that is commensurate with the amounts supplied.

Examples of the reactor that may be used include a vessel type reactor, a tube type reactor, etc. For stirring a polymerization solution, a known stirrer may be used, and examples thereof include an anchor blade, a paddle blade, a propeller blade, a lattice blade, a helical ribbon blade, and a Maxblend blade.

Each component supplied to the reactor, such as the conjugated diene, compound of formula (I), other optional monomer, hydrocarbon solvent, or alkali metal catalyst, may be supplied to the reactor as a single component or as a mixture of two or more components as long as the effect is not impaired. Furthermore, the component may be supplied as a solution in which it is dissolved in a solvent that does not deactivate the alkali metal catalyst, such as tetrahydrofuran or hexane.

When polymerization is carried out using two or more reactors, each of the above-mentioned components supplied to the reactors may, as long as the effect is not impaired, be supplied to any reactor, and may be supplied to only one reactor or two or more reactors.

When a polymer modifier is used, it is preferable to use a polymerization system equipped with two or more reactors and supply the polymer modifier to the most downstream reactor of the polymerization system.

From the viewpoint of kneading processability and fuel economy, the total amount of compound of formula (I) supplied for polymerization is preferably not less than 0.1 mol per mol of the alkali metal originating from the alkali metal catalyst supplied for polymerization, and more preferably not less than 1 mol. Furthermore, from the viewpoint of economy, it is preferably not more than 20 moles, and more preferably mot more than 10 moles.

Polymerization may be carried out by fully charging the interior of the reactor with polymerization solution, or by providing a gas phase portion. The gas phase portion may be a monomer gas phase or an inert gas phase such as a nitrogen or argon phase. Furthermore, monomer vapor, etc. in the gas phase portion may be taken out from the reactor, the vapor may be condensed by a condenser, and the condensate may be returned to the reactor.

The polymerization temperature is usually 25° C. to 100° C., preferably 35° C. to 90° C., and more preferably 50° C. to 80° C. The polymerization pressure is usually 0 to 5 MPa, and preferably 0 to 1 MPa.

The average residence time of the polymerization solution in each polymerization reactor is usually 5 min to 5 hours, and preferably 10 min to 3 hours. The stirring rotational speed is usually 10 to 600 rpm. From the viewpoint of mixture uniformity, it is not less than 30 rpm, more preferably not less than 50 rpm, and yet more preferably not less than 70 rpm. Furthermore, from the viewpoint of economy, it is preferably mot more than 400 rpm, and more preferably not more than 200 rpm.

The conjugated diene polymer may be recovered from the polymerization solution by a known recovery method such as, for example, (1) a method in which a coagulant is added to the polymerization solution or (2) a method in which steam is added to the polymerization solution. The conjugated diene polymer thus recovered may be dried by a known dryer such as a band dryer or an extrusion dryer.

Furthermore, the method for producing a conjugated diene polymer of the present invention, may further comprise a treatment to replace a group of formula (II), of a polymer by a hydroxy group using hydrolysis treatment, etc. The polymer alone or the polymer composition may be subjected to the hydrolysis treatment.

From the viewpoint of strength the conjugated diene polymer of the present invention preferably has an aromatic vinyl-based constituent unit (aromatic vinyl unit), and the content of the aromatic vinyl unit, relative to 100 wt % of the total amount of the conjugated diene unit and the aromatic vinyl unit, is preferably not less than 10 wt % (the content of the conjugated diene unit being not more than 90 wt %), and more preferably not less than 15 wt % (the content of the conjugated diene unit being not more than 85 wt %). Furthermore, from the viewpoint of fuel economy, the content of the aromatic vinyl unit is preferably not more than 50 wt % (the content of the conjugated diene unit being not less than 50 wt %), and more preferably not more than 45 wt % (the content of the conjugated diene unit being not less than 55 wt %).

From the viewpoint of strength, the weight-average molecular weight of the conjugated diene polymer of the present invention is preferably not less than 100,000, and more preferably not less than 200,000.

From the viewpoint of fuel economy, the vinyl bond content of the conjugated diene polymer of the present invention is preferably not more than 80 mol %, and more preferably not more than 70 mol % per 100 mol % of the conjugated diene-based constituent unit. Furthermore, from the viewpoint of grip properties, it is preferably not less than 10 mol %, more preferably not less than 15 mol %, yet more preferably not less than 20 mol %, and particularly preferably not less than 30 mol %. The vinyl bond content can be measured by IR spectroscopy from the absorption intensity at around 910 cm⁻¹, which is an absorption peak of a vinyl group.

From the viewpoint of kneading processability and fuel economy, the molecular weight distribution of the conjugated diene polymer of the present invention is preferably 1 to 5, more preferably 1 to 4, and yet more preferably 1 to 3. The molecular weight distribution is obtained by measuring number-average molecular weight (Mn) and weight-average molecular weight (Mw) by a gel permeation chromatograph (GPC) method, and dividing Mw by Mn.

The conjugated diene polymer of the present invention may be used in a conjugated diene polymer composition by combining another polymer component, an additive, etc. therewith.

Examples of said other polymer component include conventional styrene-butadiene copolymer rubber, polybutadiene rubber, butadiene-isoprene copolymer rubber, and butyl rubber. Examples further include natural rubber, an ethylene-propylene copolymer, and an ethylene-octene copolymer. These polymer components may be used in a combination of two or more types.

In the case where another polymer component is combined with the conjugated diene polymer of the present invention, from the viewpoint of fuel economy, the amount of conjugated diene polymer of the present invention combined, with the total amount of polymer components combined (including the amount of conjugated diene polymer combined) as 100 parts by weight, is preferably not less than 10 parts by weight, and more preferably not less than 20 parts by weight.

As the additive, a known additive may be used, and examples thereof include a vulcanizer such as sulfur; a vulcanizing accelerator such as a thiazole-based vulcanizing accelerator, a thiuram-based vulcanizing accelerator, a sulfenamide-based vulcanizing accelerator, or a guanidine-based vulcanizing accelerator; a vulcanization activator such as stearic acid or zinc oxide; an organic peroxide; a filler such as silica, carbon black, calcium carbonate, talc, alumina, clay, aluminum hydroxide, or mica; a silane coupling agent; an extender oil; a processing aid; an antioxidant; and a lubricant.

Examples of the silica include dry silica (anhydrous silicic acid), wet silica (hydrated silicic acid), colloidal silica, precipitated silica, calcium silicate, and aluminum silicate. One type thereof may be used on its own, or two or more types thereof may be used in combination. The BET specific surface area of the silica is usually 50 to 250 m²/g. The BET specific surface area is measured in accordance with ASTM D1993-03. As a commercial product, product names VN3, AQ, ER, and RS-150 manufactured by Tosoh Silica Corporation, product names Zeosil 1115 MP and 1165 MP manufactured by Rhodia, etc. may be used.

Examples of the carbon black include furnace black, acetylene black, thermal black, channel black, and graphite. With regard to the carbon black, channel carbon black such as EPC, MPC, or CC; furnace carbon black such as SAF, ISAF, HAF, MAF, FEF, SRF, GPF, APF, FF, CF, SCF, or ECF; thermal carbon black such as FT or MT; and acetylene carbon black can be cited as examples. One type thereof may be used or two or more types thereof may be used in combination.

The nitrogen adsorption specific surface area (N₂SA) of the carbon black is usually 5 to 200 m²/g, and the dibutyl phthalate (DBP) absorption of the carbon black is usually 5 to 300 mL/100 g. The nitrogen adsorption specific surface area is measured in accordance with ASTM D4820-93, and the DBP absorption is measured in accordance with ASTM D2414-93. As a commercial product, product names SEAST 6, SEAST 7HM, and SEAST KH manufactured by Tokai Carbon Co., Ltd., product names CK 3 and Special Black 4A manufactured by Degussa, Inc., etc. may be used.

Examples of the silane coupling agent include vinyltrichlorosilane, vinyltriethoxysilane, vinyltris(β-methoxyethoxy)silane, β-(3,4-epoxycyclohexyl)ethyltrimethoxysilane, γ-glycidoxypropyltrimethoxysilane, γ-methacryloxypropyltrimethoxysilane, N-(β-aminoethyl)-γ-aminopropyltrimethoxysilane, N-(β-aminoethyl)-γ-aminopropylmethyldimethoxysilane, N-phenyl-γ-aminopropyltrimethoxysilane, γ-chloropropyltrimethoxysilane, γ-mercaptopropyltrimethoxysilane, γ-aminopropyltriethoxysilane, bis(3-(triethoxysilyl)propyl)disulfide, bis(3-(triethoxysilyl)propyl)tetrasulfide, γ-trimethoxysilylpropyldimethylthiocarbamyl tetrasulfide, and γ-trimethoxysilylpropylbenzothiazyl tetrasulfide. One type thereof may be used or two or more types thereof may be used in combination. As a commercial product, product names Si69 and Si75 manufactured by Degussa, Inc., etc. may be used.

Examples of the extender oil include an aromatic mineral oil (viscosity-gravity constant (V.G.C. value) 0.900 to 1.049), a naphthenic mineral oil (V.G.C. value 0.850 to 0.899), and a paraffinic mineral oil (V.G.C. value 0.790 to 0.849). The polycyclic aromatic content of the extender oil is preferably less than 3% by weight, and more preferably less than 1% by weight. The polycyclic aromatic content is measured in accordance with British Institute of Petroleum method 346/92. Furthermore, the aromatic compound content (CA) of the extender oil is preferably not less than 20% by weight. Two or more types of extender oils may be used in combination.

Examples of the vulcanizing accelerator include thiazole-based vulcanizing accelerators such as 2-mercaptobenzothiazole, dibenzothiazyl disulfide, and N-cyclohexyl-2-benzothiazylsulfenamide; thiuram-based crosslinking accelerators such as tetramethylthiuram monosulfide and tetramethylthiuram disulfide; sulfenamide-based crosslinking accelerators such as N-cyclohexyl-2-benzothiazolesulfenamide, N-t-butyl-2-benzothiazolesulfenamide, N-oxyethylene-2-benzothiazolesulfenamide, N-oxyethylene-2-benzothiazolesulfenamide, and N,N′-diisopropyl-2-benzothiazolesulfenamide; and guanidine-based vulcanizing accelerators such as diphenylguanidine, diorthotolylguanidine, and orthotolylbiguanidine. The amount thereof used is preferably 0.1 to 5 parts by weight relative to 100 parts by weight of rubber component, and more preferably 0.2 to 3 parts by weight.

When a conjugated diene polymer composition is formed by mixing a filler with the conjugated diene polymer of the present invention, the content of the filler, relative to 100 parts by weight of the content of the conjugated diene polymer of the present invention, is usually 10 to 150 parts by weight. From the viewpoint of fuel economy, the content is preferably not less than 20 parts by weight, and more preferably not less than 30 parts by weight. From the viewpoint of reinforcement being enhanced, it is preferably not more than 120 parts by weight, and more preferably not more than 100 parts by weight.

When a conjugated diene polymer composition in which a filler is combined with the conjugated diene polymer of the present invention is used, from the viewpoint of fuel economy, it is preferable to use silica as a filler. The content of the silica is preferably not less than 50 parts by weight relative to 100 parts by weight of the total content of the fillers, and more preferably not less than 70 parts by weight.

As a method for producing a conjugated diene polymer composition by mixing another polymer component, an additive, etc. with the conjugated diene polymer of the present invention, a known method such as, for example, a method in which the components are kneaded by means of a known mixer such as a roll or Banbury mixer can be used.

With regard to kneading conditions, when an additive other than a vulcanizer or a vulcanizing accelerator is mixed, the kneading temperature is usually 50° C. to 200° C. and preferably 80° C. to 190° C., and the kneading time is usually 30 sec to 30 min and preferably 1 min to 30 min. When a vulcanizer or a vulcanizing accelerator is mixed, the kneading temperature is usually not more than 100° C., and preferably room temperature to 80° C. A composition in which a vulcanizer or a vulcanizing accelerator is combined is usually used after carrying out a vulcanization treatment such as press vulcanization. The vulcanization temperature is usually 120° C. to 200° C., and preferably 140° C. to 180° C.

The conjugated diene polymer and the conjugated diene polymer composition of the present invention have excellent kneading processability. The fuel economy is also excellent, and the grip properties are also good.

The conjugated diene polymer and the conjugated diene polymer composition of the present invention are used for tires, shoe soles, flooring materials, vibration-proofing materials, etc., and are particularly suitably used for tires.

In accordance with the present invention, there can be provided a conjugated diene polymer having excellent kneading processability and a polymer composition containing the conjugated diene polymer and a filler. Furthermore, the polymer composition has excellent fuel economy and good grip properties.

### EXAMPLES

The present invention is explained below by reference to Examples.

Physical properties were evaluated by the following methods.

### 1. Mooney Viscosity (ML₁₊₄)

The Mooney viscosity of a polymer was measured at 100° C. in accordance with JIS K6300 (1994).

### 2. Vinyl Bond Content (Units: Mol % Proportion of Conjugated Diene-Based 1,2-Addition Constituent Unit)

The vinyl bond content of a polymer was determined by IR spectroscopy from the absorption intensity at around 910 cm⁻¹, which is an absorption peak of a vinyl group.

### 3. Styrene Unit Content (Units: % by Weight)

The styrene unit content of a polymer was determined from refractive index in accordance with JIS K6383 (1995).

### 4. Weight-Average Molecular Weight (Mw) and Molecular Weight Distribution (Mw/Mn)

Weight-average molecular weight (Mw) and number-average molecular weight (Mn) were measured under conditions (1) to (8) below by a gel permeation chromatograph (GPC) method, and the molecular weight distribution (Mw/Mn) of a polymer was determined.

(1) Instrument: HLC-8020 manufactured by Tosoh Corporation
(2) Separation column: GMH-XL (2 columns in tandem) manufactured by Tosoh Corporation
(3) Measurement temperature: 40° C.
(4) Carrier: tetrahydrofuran
(5) Flow rate: 0.6 mL/min
(6) Amount injected: 5 μL
(7) Detector: differential refractometer
(8) Molecular weight standard: standard polystyrene

### 5. Kneading Processability

100 parts by weight of polymer, 78.4 parts by weight of silica (product name: Ultrasil VN3-G, manufactured by Degussa, Inc.), 6.4 parts by weight of a silane coupling agent (product name: Si69, manufactured by Degussa, Inc.), 6.4 parts by weight of carbon black (product name: DIABLACK N339, manufactured by Mitsubishi Chemical Corp.), 47.6 parts by weight of an extender oil (product name: X-140, manufactured by Kyodo Sekiyu), 1.5 parts by weight of an antioxidant (product name: Antigene 3C, manufactured by Sumitomo Chemical Co., Ltd.), and 2 parts by weight of stearic acid were kneaded by means of a Labo Plastomill, 2 parts by weight of zinc oxide and 1.5 parts by weight of a wax (product name: Sunnoc N, manufactured by Ouchi Shinko Chemical Industrial Co., Ltd.) were kneaded by means of the Labo Plastomill at a kneading start temperature of 70° C. for 5 minutes (the temperature being increased to 120° C. by the end), and the polymer composition was then taken out from the Labo Plastomill. The operability when taking out the polymer composition was evaluated using the criteria below. The larger the number, the better the kneading processability.

### Evaluation Criteria

1: adherence of the polymer composition was observed, and it took time to take out the polymer composition.

2: adherence of the polymer composition was observed, and it took some time to take out the polymer composition.

3: some adherence of the polymer composition was observed, but it did not take very much time to take out the polymer composition.

4: hardly any adherence of the polymer composition was observed, and it did not take any time to take out the polymer composition.

### 6. Fuel Economy

The loss tangent (tan δ (70° C.)) at 70° C. of the vulcanized sheet was measured using a viscoelastometer (Ueshima Seisakusho Co., Ltd.) under conditions of a strain of 1% and a frequency of 10 Hz. The smaller this value, the better the fuel economy.

### 7. Grip Properties

The loss tangent (tan δ (0° C.)) at 0° C. of the vulcanized sheet was measured using a viscoelastometer (Ueshima Seisakusho Co., Ltd.) under conditions of a strain of 0.25% and a frequency of 10 Hz. The greater this value, the better the grip properties.

### Example 1

Continuous polymerization was carried out using a polymerization system in which a 2 L capacity reactor (first polymerization vessel) and a 2 L capacity reactor (second polymerization vessel) were connected in series.

The interior of the first polymerization vessel and the interior of the second polymerization vessel were washed, dried, and flushed with dry nitrogen in advance, and subsequently the first polymerization vessel was charged with 1.4 L of hexane and the second polymerization vessel was charged with 0.5 L of hexane, thus carrying out a scavenging treatment.

Continuously supplied to the first polymerization vessel were 1,3-butadiene at 1.8 g/min, a hexane solution of bis(diethylamino)methylvinylsilane at 2.40 mmol as the amount of bis(diethylamino)methylvinylsilane/hour, styrene at 0.7 g/min, a hexane solution of tetrahydrofuran and ethylene glycol diethyl ether (tetrahydrofuran concentration: 5.0 mol/L, ethylene glycol diethyl ether concentration: 300 wt ppm) at 12 mL/min, and a hexane solution of n-butyllithium at 2.54 mmol as the amount of n-butyllithium/hour. The polymerization solution was continuously drawn off from the first polymerization vessel such that the polymerization solution within the first polymerization vessel was 1.5 L, and supplied to the second polymerization vessel. The polymerization solution was continuously drawn off from the second polymerization vessel into a storage vessel such that the polymerization solution within the second polymerization vessel was 1.5 L. During polymerization, the polymerization vessel internal temperature was 53° C., the stirring rotational speed was 170 rpm, and polymerization was carried out for 5.5 hours. In the polymerization, the total amount of 1,3-butadiene supplied to the first polymerization vessel was 594 g, the total amount of bis(diethylamino)methylvinylsilane supplied to the first polymerization vessel was 2.83 g (13.2 mmol), the total amount of styrene supplied to the first polymerization vessel was 231 g, and the total amount of n-butyllithium supplied to the first polymerization vessel was 14.0 mmol.

1 mL of methanol was added to the polymerization solution thus obtained. Subsequently, to the polymerization solution were added, relative to 100 parts by weight of the polymer in the polymerization solution, 0.4 parts by weight of 2-tert-butyl-6-(3-tert-butyl-2-hydroxy-5-methylbenzyl)-4-methylphenyl acrylate (product name: Sumilizer GM, manufactured by Sumitomo Chemical Co., Ltd.), and 0.2 parts by weight of pentaerythrityl tetrakis(3-laurylthiopropionate) (product name: Sumilizer TP-D, manufactured by Sumitomo Chemical Co., Ltd.). The content of the polymer in the polymerization solution was determined in advance by drying a small amount of polymerization solution taken from the polymerization solution thus obtained and taking out the polymer in this small amount of polymerization solution. The polymerization solution was evaporated at normal temperature for 24 hours and further dried under vacuum at 55° C. for 12 hours, thus giving a polymer. The results of evaluation of the polymer are given in Table 1.

100 parts by weight of the polymer thus obtained, 78.4 parts by weight of silica (product name: Ultrasil VN3-G, manufactured by Degussa, Inc.), 6.4 parts by weight of a silane coupling agent (product name: Si69, manufactured by Degussa, Inc.), 6.4 parts by weight of carbon black (product name: DIABLACK N339, manufactured by Mitsubishi Chemical Corp.), 47.6 parts by weight of an extender oil (product name: X-140, manufactured by Kyodo Sekiyu), 1.5 parts by weight of an antioxidant (product name: Antigene 3C, manufactured by Sumitomo Chemical Co., Ltd.), 2 parts by weight of stearic acid, 2 parts by weight of zinc oxide, 1 part by weight of a vulcanizing accelerator (product name: Soxinol CZ, manufactured by Sumitomo Chemical Co., Ltd.), 1 part by weight of a vulcanizing accelerator (product name: Soxinol D, manufactured by Sumitomo Chemical Co., Ltd.), 1.5 parts by weight of a wax (product name: Sunnoc N, manufactured by Ouchi Shinko Chemical Industrial Co., Ltd.), and 1.4 parts by weight of sulfur were kneaded by means of a Labo Plastomill at a kneading start temperature of 70° C. for 5 minutes (the temperature being increased to 120° C. by the end) to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Comparative Example 1

Continuous polymerization was carried out using a polymerization system in which a 2 L capacity reactor (first polymerization vessel) and a 2 L capacity reactor (second polymerization vessel) were connected in series.

The interior of the first polymerization vessel and the interior of the second polymerization vessel were washed, dried, and flushed with dry nitrogen in advance, and subsequently the first polymerization vessel was charged with 1.4 L of hexane and the second polymerization vessel was charged with 0.5 L of hexane, thus carrying out a scavenging treatment.

Continuously supplied to the first polymerization vessel were 1,3-butadiene at 1.8 g/min, styrene at 0.7 g/min, a hexane solution of tetrahydrofuran and ethylene glycol diethyl ether (tetrahydrofuran concentration: 5.0 mol/L, ethylene glycol diethyl ether concentration: 300 wt ppm) at 12 mL/min, and a hexane solution of n-butyllithium at 2.17 mmol as the amount of n-butyllithium/hour. The polymerization solution was continuously drawn off from the first polymerization vessel such that the polymerization solution within the first polymerization vessel was 1.5 L, and supplied to the second polymerization vessel. The polymerization solution was continuously drawn off from the second polymerization vessel into a storage vessel such that the polymerization solution within the second polymerization vessel was 1.5 L. During polymerization, the polymerization vessel internal temperature was 53° C., the stirring rotational speed was 170 rpm, and polymerization was carried out for 5 hours. In the polymerization, the total amount of 1,3-butadiene supplied to the first polymerization vessel was 540 g, the total amount of styrene supplied to the first polymerization vessel was 210 g, and the total amount of n-butyllithium supplied to the first polymerization vessel was 10.9 mmol.

1 mL of methanol was added to the polymerization solution thus obtained. Subsequently, to the polymerization solution were added, relative to 100 parts by weight of the polymer in the polymerization solution, 0.4 parts by weight of 2-tert-butyl-6-(3-tert-butyl-2-hydroxy-5-methylbenzyl)-4-methylphenyl acrylate (product name: Sumilizer GM, manufactured by Sumitomo Chemical Co., Ltd.), and 0.2 parts by weight of pentaerythrityl tetrakis(3-laurylthiopropionate) (product name: Sumilizer TP-D, manufactured by Sumitomo Chemical Co., Ltd.). The content of the polymer in the polymerization solution was determined in advance by drying a small amount of polymerization solution taken from the polymerization solution thus obtained and taking out the polymer in this small amount of polymerization solution. The polymerization solution was evaporated at normal temperature for 24 hours and further dried under vacuum at 55° C. for 12 hours, thus giving a polymer. The results of evaluation of the polymer are given in Table 1.

100 parts by weight of the polymer thus obtained, 78.4 parts by weight of silica (product name: Ultrasil VN3-G, manufactured by Degussa, Inc.), 6.4 parts by weight of a silane coupling agent (product name: Si69, manufactured by Degussa, Inc.), 6.4 parts by weight of carbon black (product name: DIABLACK N339, manufactured by Mitsubishi Chemical Corp.), 47.6 parts by weight of an extender oil (product name: X-140, manufactured by Kyodo Sekiyu), 1.5 parts by weight of an antioxidant (product name: Antigene 3C, manufactured by Sumitomo Chemical Co., Ltd.), 2 parts by weight of stearic acid, 2 parts by weight of zinc oxide, 1 part by weight of a vulcanizing accelerator (product name: Soxinol CZ, manufactured by Sumitomo Chemical Co., Ltd.), 1 part by weight of a vulcanizing accelerator (product name: Soxinol D, manufactured by Sumitomo Chemical Co., Ltd.), 1.5 parts by weight of a wax (product name: Sunnoc N, manufactured by Ouchi Shinko Chemical Industrial Co., Ltd.), and 1.4 parts by weight of sulfur were kneaded by means of a Labo Plastomill at a kneading start temperature of 70° C. for 5 minutes (the temperature being increased to 120° C. by the end) to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Comparative Example 2

A 20 L capacity stainless polymerization reactor was washed, dried, flushed with dry nitrogen, and charged with 10.2 kg of hexane (specific gravity 0.68 g/cm³), 547 g of 1,3-butadiene, 173 g of styrene, 6.1 mL of tetrahydrofuran, and 5.0 mL of ethylene glycol diethyl ether. Subsequently, 14.4 mmol of n-butyllithium was poured in as an n-hexane solution, and copolymerization of 1,3-butadiene and styrene was carried out for 3 hours. During polymerization, the stirring rotational speed was 173 rpm, the polymerization vessel internal temperature was 65° C., and the monomers were continuously supplied to the polymerization reactor for 3 hours.

After the polymerization had been carried out, 2.16 mmol of silicon tetrachloride was added to the polymerization reactor, and the polymerization solution was stirred for 15 minutes. The amount of 1,3-butadiene supplied during the entire polymerization was 821 g, and the amount of styrene supplied was 259 g.

2 mL of methanol was added to the polymerization solution thus obtained. Subsequently, to the polymerization solution were added, relative to 100 parts by weight of the polymer in the polymerization solution, 0.4 parts by weight of 2-tert-butyl-6-(3-tert-butyl-2-hydroxy-5-methylbenzyl)-4-methylphenyl acrylate (product name: Sumilizer GM, manufactured by Sumitomo Chemical Co., Ltd.), and 0.2 parts by weight of pentaerythrityl tetrakis(3-laurylthiopropionate) (product name: Sumilizer TP-D, manufactured by Sumitomo Chemical Co., Ltd.). The content of the polymer in the polymerization solution was determined in advance by drying a small amount of polymerization solution taken from the polymerization solution thus obtained and taking out the polymer in this small amount of polymerization solution. The polymerization solution was evaporated at normal temperature for 24 hours and further dried under vacuum at 55° C. for 12 hours, thus giving a polymer. The results of evaluation of the polymer are given in Table 1.

100 parts by weight of the polymer thus obtained, 78.4 parts by weight of silica (product name: Ultrasil VN3-G, manufactured by Degussa, Inc.), 6.4 parts by weight of a silane coupling agent (product name: Si69, manufactured by Degussa, Inc.), 6.4 parts by weight of carbon black (product name: DIABLACK N339, manufactured by Mitsubishi Chemical Corp.), 47.6 parts by weight of an extender oil (product name: X-140, manufactured by Kyodo Sekiyu), 1.5 parts by weight of an antioxidant (product name: Antigene 3C, manufactured by Sumitomo Chemical Co., Ltd.), 2 parts by weight of stearic acid, 2 parts by weight of zinc oxide, 1 part by weight of a vulcanizing accelerator (product name: Soxinol CZ, manufactured by Sumitomo Chemical Co., Ltd.), 1 part by weight of a vulcanizing accelerator (product name: Soxinol D, manufactured by Sumitomo Chemical Co., Ltd.), 1.5 parts by weight of a wax (product name: Sunnoc N, manufactured by Ouchi Shinko Chemical Industrial Co., Ltd.), and 1.4 parts by weight of sulfur were kneaded by means of a Labo Plastomill at a kneading start temperature of 70° C. for 5 minutes (the temperature being increased to 120° C. by the end) to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

TABLE 1

| | | Example | Comparative Example | |
|---|---|---|---|---|
| | | 1 | 1 | 2 |
| Vinyl bond content | Mole % | 59 | 59 | 59 |
| Styrene unit content | Weight % | 24 | 24 | 25 |
| Weight-average molecular weight | — | 210,000 | 230,400 | 490,800 |
| Molecular weight distribution | — | 1.91 | 2.11 | 1.66 |
| Kneading processability | — | 4 | 2 | 4 |
| Fuel economy tanδ (70° C.) | — | 0.162 | 0.247 | 0.207 |
| Grip properties tanδ (0° C.) | — | 1.049 | 0.596 | 0.737 |

1. A continuous method for producing a conjugated diene polymer, comprising:
polymerizing a conjugated diene, a compound of formula (I) below, and optionally other monomer in the presence of an alkali metal catalyst in a hydrocarbon solvent, 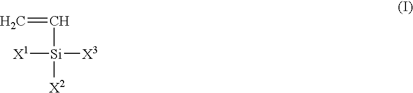
wherein X¹, X², and X³ independently denote a group of formula (II) below, a hydrocarbyl group, or a substituted hydrocarbyl group, and at least one of X¹, X², and X³ is a group of formula (II) below, 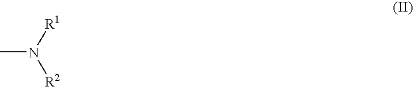
wherein R¹ and R² independently denote a hydrocarbyl group having 1 to 9 carbon atoms, a substituted hydrocarbyl group having 1 to 9 carbon atoms, a silyl group, or a substituted silyl group, and R¹ and R² may be bonded so as to form, together with the nitrogen atom, a ring structure.

2. The method according to claim 1, wherein said other monomer is an aromatic vinyl compound.

3. The method according to claim 1, wherein the vinyl bond content of the conjugated diene polymer is not less than 20 mol % and not more than 70 mol % per 100 mol % of the conjugated diene-based constituent unit.

4. A conjugated diene polymer obtained by the method according to claim 1.

5. A conjugated diene polymer composition comprising:
the conjugated diene polymer according to claim 4; and
a filler.
